(19) United States
(12) Patent Application Publication
(10) Pub. No.: US 2021/0217422 A1
(43) Pub. Date: Jul. 15, 2021

(54) METHOD FOR ESTABLISHING LINK TO DISPLAY RELEVANT DATA OF KEYWORD AND ELECTRONIC DEVICE EMPLOYING THE METHOD

(71) Applicants: Fu Tai Hua Industry (Shenzhen) Co., Ltd., Shenzhen (CN); HON HAI PRECISION INDUSTRY CO., LTD., New Taipei (TW)

(72) Inventors: CHIA-HUNG CHOU, New Taipei (TW); CHIA-CHUN WU, New Taipei (TW); CHUAN-TE CHAN, New Taipei (TW); MING-CHUAN HSU, New Taipei (TW); YEN-JEN HUANG, New Taipei (TW); CHI-JSUNG LEE, New Taipei (TW)

(21) Appl. No.: 17/073,731

(22) Filed: Oct. 19, 2020

(30) Foreign Application Priority Data
Jan. 13, 2020 (CN) 202010033501.5

(51) Int. Cl. G10L 15/30; G10L 15/02; G10L 15/22

(52) U.S. Cl. CPC G10L 15/30; G10L 15/22; G10L 15/02

(57) ABSTRACT

A method for establishing a link for a keyword within a page or document being currently displayed includes detecting at least one keyword in the current display of the electronic device, and uploading the at least one keyword to a server. The method further includes receiving a link of relevant data of each keyword from the server, and displaying the link of the relevant data corresponding to each keyword in the currently displayed page of the display screen.

### CROSS-REFERENCE TO RELATED APPLICATIONS

This application claims priority to Chinese Patent Application No. 202010033501.5 filed on Jan. 13, 2020, the contents of which are incorporated by reference herein.

### FIELD

The subject matter herein generally relates to data processing.

### BACKGROUND

Electronic devices, such as mobile phones and personal computers, can access the internet. When users are browsing various web pages with the electronic device, they may need to use a special search engine or open a new page for the purpose of searching for or translating unknown keywords.

### BRIEF DESCRIPTION OF THE DRAWINGS

Many aspects of the disclosure can be better understood with reference to the following drawings. The components in the drawings are not necessarily drawn to scale, the emphasis instead being placed upon clearly illustrating the principles of the disclosure. Moreover, in the drawings, like reference numerals designate corresponding parts throughout the several views.

FIG. 1 is a schematic diagram of the application environment of one embodiment of a method for providing a link and relevant content for the keyword.

FIG. 2 is a block diagram of one embodiment of an electronic device.

FIG. 3 is a block diagram of one embodiment of the electronic device including a device for establishing a keyword link.

FIG. 4 illustrates a flowchart of one embodiment of the method of FIG. 1.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. Also, the description is not to be considered as limiting the scope of the embodiments described herein. The drawings are not necessarily to scale and the proportions of certain parts may be exaggerated to better illustrate details and features of the present disclosure.

The present disclosure, including the accompanying drawings, is illustrated by way of examples and not by way of limitation. It should be noted that references to “an” or “one” embodiment in this disclosure are not necessarily to the same embodiment, and such references mean “at least one.”

The term “module”, as used herein, refers to logic embodied in hardware or firmware, or to a collection of software instructions, written in a programming language, such as, Java, C, or assembly. One or more software instructions in the modules can be embedded in firmware, such as in an EPROM. The modules described herein can be implemented as either software and/or hardware modules and can be stored in any type of non-transitory computer-readable medium or another storage device. Some non-limiting examples of non-transitory computer-readable media include CDs, DVDs, BLU-RAY™, flash memory, and hard disk drives. The term “comprises” means “including, but not necessarily limited to”; it specifically indicates open-ended inclusion or membership in a so-described combination, group, series, and the like.

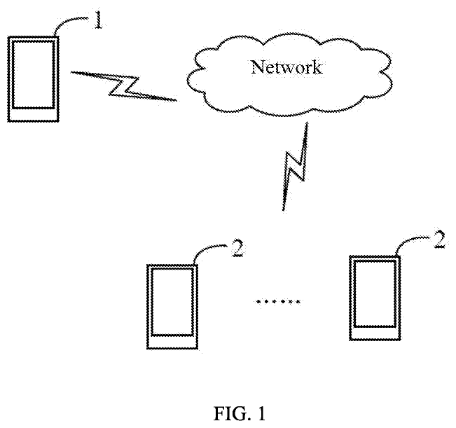

FIG. 1 shows a schematic diagram of an application environment architecture for a method of establishing a keyword link. The method is applied to an electronic device 1. The electronic device 1 is communicating with at least one server 2 through a network. The network may be a wired network or a wireless network, such as radio, WI-FI, cellular, satellite, and broadcasting.

In at least one embodiment, electronic device 1 may have a keyword link establishment program installed. For example, the electronic device 1 may be a smart phone, a personal computer, or a server. The server 2 may be a single server, a server cluster, or a cloud server, etc.

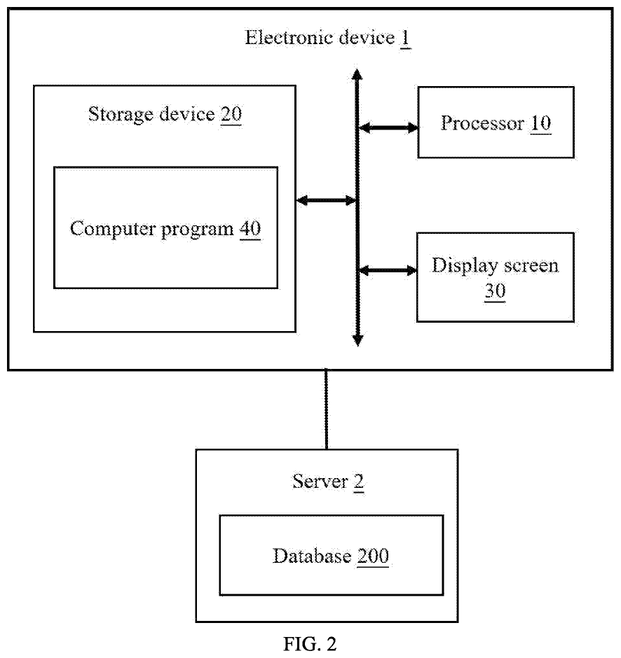

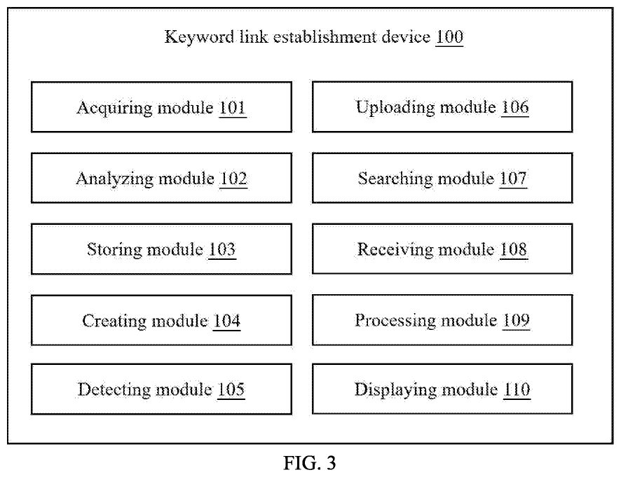

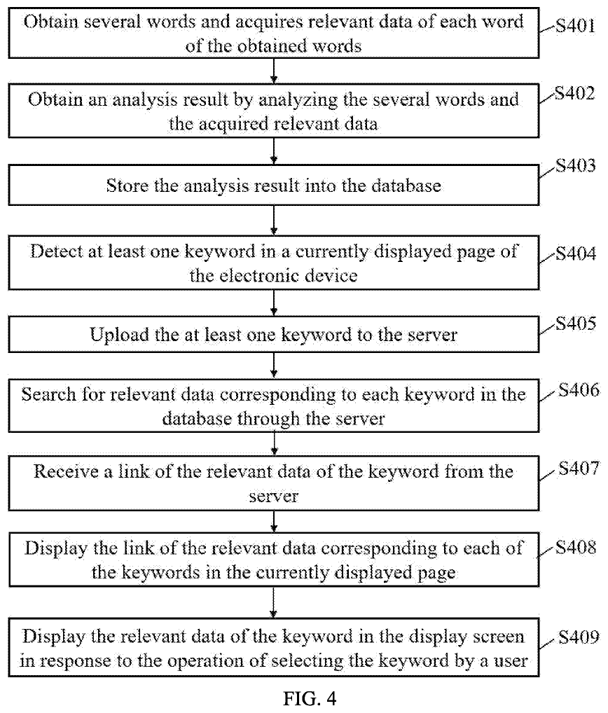

FIG. 2 shows one embodiment of an electronic device (electronic device 1). Depending on the embodiment, the electronic device 1 can include, but is not limited to, at least one processor 10, a storage device 20, and a display screen 30. The storage device 20, at least one processor 10, and the display screen 30 communicate with each other through a system bus. The electronic device 1 further includes a computer program 40, for example, program to establish keyword link. The computer program 40 is stored in the storage device 20 and is executed by the processor 10. When the processor 10 executes the computer program 40, steps of the method are implemented, for example, steps S401 to S409 shown in FIG. 4. When the processor 10 executes the computer program 40, modules of a keyword link establishment system are implemented, being module 101 to module 110 shown in FIG. 3.

In at least one embodiment, the computer program 40 may be divided into one or more modules/units, and the one or more modules/units are stored in the storage device 20 and executed by the processor 10 to complete this invention. The one or more modules/units may be a series of computer program instruction segments capable of performing specific functions, and the instruction segments are used to describe the execution process of the computer program 40 in the electronic device 1. For example, the computer program 40 may include an acquiring module 101, an analyzing module 102, a storing module 103, a creating module 104, a detecting module 105, an uploading module 106, a searching module 107, a receiving module 108, and a processing module 109 and a displaying module 110. For the specific function of each module, reference should be made to the function of each module in an embodiment of a keyword link establishment device.

In at least one embodiment, a person skilled in the art may understand that FIG. 1 illustrates only one example of the electronic device 1, other examples can comprise more or fewer components than those shown in the embodiment, or have a different configuration of the various components. For example, the electronic device 1 can further include a circuit system, input/output interface, a battery, network access devices, an operating system, buses, and so on.

In at least one embodiment, the processor 10 may be a central processing unit (CPU), or other general-purpose processors, digital signal processors DSP, application specific integrated circuits ASIC, Ready-made programmable gate array (Field-Programmable Gate Array, FPGA) or other programmable logic devices, discrete gate or transistor logic devices, discrete hardware components, etc. The general-purpose processor may be a microprocessor or the processor 10 may also be any conventional processor, etc. The processor 10 is a control center of the electronic device 1 and uses various interfaces and lines to connect various parts of the electronic device 1.

In at least one embodiment, the storage device 20 may be used to store the computer program 40 and/or modules/units, and the processor 10 executes or executes the computer programs and/or modules/units stored in the storage device 20 and calls up data stored in the storage device 20 to realize various functions of the electronic device 1. The storage device 20 may include a first area for storing programs and a second area for storing data, wherein the first area may store an operating system, application programs required by at least one function (such as a sound playback function, image playback function), and so on. The second area may store data (such as audio data, address book) created according to the use of the electronic device 1. In addition, the storage device 20 may include random access memory, and may also include a non-volatile memory, such as a hard disk, a memory, a plug-in hard disk, a Smart Media Card SMC, and a secure digital (SD) Card, a flash card, at least one disk storage device, flash memory device, or another non-volatile solid-state storage device.

In at least one embodiment, the display screen 30 is a touch display screen, and can be used to display a user interface of the electronic device 1.

In at least one embodiment, the server 2 may include at least a database 200 for storing several words and related materials corresponding to many words in the vocabulary of a language.

FIG. 3 is a block diagram of one embodiment of the electronic device including a keyword link establishing device.

In at least one embodiment, the keyword link establishing device 100 runs in the electronic device 1. The keyword link establishing device 100 may include a plurality of function modules composed of program code segments. The program codes of each program segment in the keyword link establishing device 100 may be stored in the storage device 20 of the electronic device 1 and executed by the at least one processor 10 to implement the keyword link establishing function.

In at least one embodiment, the keyword link establishing device 100 can be divided into multiple functional modules. Referring to FIG. 3, the functional modules may include an acquiring module 101, an analyzing module 102, a storing module 103, a creating module 104, a detecting module 105, an uploading module 106, a searching module 107, a receiving module 108, and a processing module 109 and a displaying module 110. The modules referred to herein refer to a series of computer program segments that can be executed by at least one processor and can perform fixed functions, and are stored in the storage device 20. It can be understood that, in other embodiments, the above-mentioned modules may also be program instructions or firmware solidified in the processor 10.

In at least one embodiment, the acquiring module 101 can obtain several words and acquire relevant data of each word of the obtained words.

In at least one embodiment, the acquiring module 101 can obtain several words and the relevant data through an open application programming interface, web crawlers, and open data interfaces of government agencies. The relevant data of each word can include translation or definition of each word, explanation of each word, and encyclopedia entry of each word, and so on.

In at least one embodiment, the analyzing module 102 can obtain an analysis result by analyzing the several words and the acquired relevant data.

In at least one embodiment, the words acquired by the acquiring module 101 include singular and plural, various tenses, and parts of speech. The analyzing module 102 can analyze several words by stop word processing, case conversion, and part-of-speech conversion.

In at least one embodiment, articles, prepositions, and conjunctions are stop words, the stop word processing is deleting or filtering the stop words. In at least one embodiment, the database 200 may store a list of stop words. The analyzing module 102 can delete or filter the stop words of the acquired relevant data according to the list. For example, the acquiring module 101 acquires a word “apple”, and the relevant data of the word “apple” may state “Apple is a kind of fruit, a genus of apples in the family Rosacea subfamily. An apple tree is deciduous, an apple is generally rich in minerals and vitamins.” Then, the analyzing module 102 can obtain the analysis result “fruits, rosacea apple subfamily apples, plants, trees, deciduous trees, apple is rich in minerals, vitamins”, by stop word processing the relevant data. The case conversion is that the analyzing module 102 converts the capital letters in English words into lower case letters. The part-of-speech conversion includes stemming, tense conversion, and singular and plural conversion.

In at least one embodiment, the storing module 103 can store the analysis result into the database 200.

In at least one embodiment, the storing module 103 can upload several words analyzed and processed by the analyzing module 102 and the relevant data of each word to the server 2 and stores the same in the database 200 through the server 2.

In at least one embodiment, the creating module 104 can create an index of each word of the several words and the relevant data of each word in the database 200.

In at least one embodiment, the index is a separate, physical storage structure that sorts the values of one or more columns in a database table, which is equivalent to the directory of the database 200. The creating module 104 can identify a domain of each word of the database 200, create a data list with the domain as the column header according to the domain of each word, and create an index corresponding to the relevant data of each word or words according to the data list.

In at least one embodiment, the detecting module 105 can detect at least one keyword in a currently displayed page of the electronic device 1.

In at least one embodiment, the page is displayed on the electronic device 1 is a webpage through a browser. It can be understood that, in other embodiments, the displayed page may also be another page displaying text, such as a Microsoft Office Power point or Word document, social software chat page, a shopping commodity page, and the like.

In at least one embodiment, the detecting module 105 can detect the number of occurrences of each word in the currently displayed page of the electronic device 1, and determine that words with a number of occurrences greater than or equal to a preset number of times are keywords. For example, the preset number of times is three. In other embodiments, the preset number of times may also be set to another number according to actual needs.

In other embodiments, users can preset the domain of the keywords. The detecting module 105 can identify a domain of each word in the currently displayed page automatically, and determine whether the identified domain of each word is the same as the preset domain, and determine that the word is a keyword if the identified domain of the word is the same as the preset domain. The preset domain can include technology, food, education, and so on.

In other embodiment, the storage device 20 can store historical browsing data of the electronic device 1. The historical browsing data can include browsing data of applications corresponding to the currently displayed page. For example, if the currently displayed page is a webpage of a browser, the historical browsing data is the browsing data previously saved by the browser. The detecting module 105 can detect one by one whether each word in the currently displayed page has appeared in the historical browsing data stored in the storage device 20, and determine that words that have not appeared in the historical browsing data are keywords.

In at least one embodiment, the uploading module 106 can upload the keywords to the server 2.

In at least one embodiment, the uploading module 106 uploads the keywords of the currently displayed page of the electronic device 1 to the server 2 in response to a trigger operation of a preset hot key of the user. The preset hot key may be a preset key or gesture. The uploading module 106 uploads the keywords to the server 2 based on Hyper Text Transfer Protocol HTTP.

In at least one embodiment, the application corresponding to the currently displayed page of the electronic device 1 provides an option with keyword link matching function, if the user starts the keyword link matching function through the option. Whenever the electronic device 1 displays a page, the uploading module 106 automatically uploads the keywords on the currently displayed page of the electronic device 1 as detected by the detecting module 105 to the server 2.

In at least one embodiment, the searching module 107 can search for relevant data corresponding to each keyword in the database 200 through the server 2.

In at least one embodiment, the searching module 107 can send a search command to the server 2, the server 2 can search for the relevant data corresponding to the keywords in the database 200 based on the index after receiving the search command. In detail, the server 2 can identify a domain of each keyword, and obtain several words of the identified domain based on the index of the database 200, and search for the word that is the same as the keyword from the obtained several words, and acquire relevant data of the searched word.

In at least one embodiment, the receiving module 108 can receive a link of the relevant data of the keyword from the server 2.

In at least one embodiment, if the server 2 matches the words corresponding to the keywords in the database 200, the server 2 can establish a link for relevant data of the words corresponding to the keywords. The link is a hyperlink.

In at least one embodiment, the server 2 can establish a hyperlink for relevant data of the words corresponding to the keywords by HTML5 language. If the hyperlink is to display a floating window, the corresponding HTML5 language is <iframe src=“relevant data of the database of the server”>. If the hyperlink is to display a new page instead of the current page, the corresponding HTML5 language is <a href=“relevant data of the database of the server” target=“_self”>new page</a>. If the hyperlink is to display a new page not instead of the current page, the corresponding HTML5 language is <a href=“relevant data of the database of the server” target=“_blank”>new page</a>.

In at least one embodiment, the server 2 can send the link to the electronic device 1, and the receiving module 108 can receive a link of the relevant data of the keyword from the server 2.

In at least one embodiment, the processing module 109 can display the link of the relevant data corresponding to each of the keywords in the currently displayed page.

In at least one embodiment, the processing module 109 can add the link to a document object model of the currently displayed page, and make the currently displayed page display the link of each keyword. Then, the user can click the keyword to trigger the link.

In at least one embodiment, the displaying module 110 can display the relevant data of the keyword in the display screen 30 in response to the user operation of selecting the keyword.

In at least one embodiment, the user operation of selecting the keyword is to touch the keyword with a finger or click the keyword with a mouse. In response to the operation of selecting the keyword, the displaying module 110 can control the electronic device 1 to display the relevant data of the keyword in the display screen 30.

In at least one embodiment, the displaying module 110 can control the electronic device 1 to display the relevant data of the keyword in the display screen 30 by a floating window, or a new page, or a page replacing the currently displayed page. The display format of the relevant data is determined by the HTML5 language corresponding to the link.

FIG. 4 illustrates a flowchart of a method for establishing a link of a keyword. In an example embodiment, the method is performed by execution of computer-readable software program codes or instructions by the processor 10 of the electronic device 1.

Referring to FIG. 4, the method is provided by way of example, as there are a variety of ways to carry out the method. The method described below can be carried out using the configurations illustrated in FIG. 3, for example, and various elements of these figures are referenced in explaining the method. Each block shown in FIG. 4 represents one or more processes, methods, or subroutines, carried out in the method. Furthermore, the illustrated order of blocks is illustrative only and the order of the blocks can be changed. Additional blocks can be added or fewer blocks can be utilized without departing from this disclosure. The example method can begin at block S401.

At block S401, the acquiring module 101 can obtain several words and acquires relevant data of each word of the obtained words.

At block S402, the analyzing module 102 can obtain an analysis result by analyzing the several words and the acquired relevant data.

At block S403, the storing module 103 can store the analysis result into the database 200.

At block S404, the detecting module 105 can detect at least one keyword in a currently displayed page of the electronic device 1.

At block S405, the uploading module 106 can upload the at least one keyword to the server 2.

At block S406, the searching module 107 can search for relevant data corresponding to each keyword in the database 200 through the server 2.

At block S407, the receiving module 108 can receive a link of the relevant data of the keyword from the server 2.

At block S408, the processing module 109 can display the link of the relevant data corresponding to each of the at least one keyword in the currently displayed page.

At block S409, the displaying module 110 can display the relevant data of the keyword in the display screen 30 in response to the operation of selecting the keyword by a user.

In at least one embodiment, the above keyword link establishment device, method, and electronic device can automatically establish a keyword link on the currently displayed page when the user browses the page. The user can click the link to view the corresponding relevant data without manual search, simplifying the user operation effectively improves the user experience.

It should be emphasized that the above-described embodiments of the present disclosure, including any particular embodiments, are merely possible examples of implementations, set forth for a clear understanding of the principles of the disclosure. Many variations and modifications can be made to the above-described embodiment(s) of the disclosure without departing substantially from the spirit and principles of the disclosure. All such modifications and variations are intended to be included herein within the scope of this disclosure and protected by the following claims.

What is claimed is:

1. An electronic device comprising:
a display screen;
a storage device; and
at least one processor, wherein
the storage device storing one or more programs that, when executed by the at least one processor, cause the at least one processor to:
detect at least one keyword in a currently displayed page of the electronic device;
upload the at least one keyword to a server;
receive a link of relevant data of each keyword from the server; and
display the link of the relevant data corresponding to each keyword in the currently displayed page of the display screen.

2. The electronic device according to claim 1, wherein the at least one processor is further caused to:
obtain a plurality of words from the currently displayed page of the electronic device;
acquire relevant data of each word of the obtained words;
obtain an analysis result by analyzing the plurality of words and the acquired relevant data;
store the analysis result into a database.

3. The electronic device according to claim 2, wherein the at least one processor is further caused to:
create an index of each word of the plurality of words and the relevant data of each word in the database by the server; and
search for the at least one keyword and the relevant data corresponding to each keyword in the database based on the index.

4. The electronic device according to claim 1, wherein the at least one processor is further caused to:
upload the at least one keyword to the server in response to a trigger operation on a preset hot key of the electronic device by a user; or
upload the at least one keyword to the server in response to start a keyword link matching function of the electronic device.

5. The electronic device according to claim 2, wherein the at least one processor is further caused to:
detect the number of occurrences of each word in the currently displayed page of the electronic device; and
determine that words with number of occurrences greater than or equal to a preset number of times are keywords.

6. The electronic device according to claim 2, wherein the at least one processor is further caused to:
identify a domain of each word in the currently displayed page;
determine whether the identified domain of each word is the same as a preset domain; and
determine that the word is a keyword if the identified domain of the word is the same as the preset domain.

7. The electronic device according to claim 2, wherein the at least one processor is further caused to:
detect whether each word in the currently displayed page has appeared in the historical browsing data stored in the storage device; and
determine that words that have not appeared in the historical browsing data are keywords.

8. A link of keyword establishing method applicable in an electronic device, the electronic device comprising a display screen, the method comprising:
detecting at least one keyword in a currently displayed page of the electronic device;
uploading the at least one keyword to a server;
receiving a link of relevant data of each keyword from the server; and
displaying the link of the relevant data corresponding to each keyword in the currently displayed page of the display screen.

9. The method according to claim 8, the method further comprises:
obtaining a plurality of words from the currently displayed page of the electronic device;
acquiring relevant data of each word of the obtained words;
obtaining an analysis result by analyzing the plurality of words and the acquired relevant data;
storing the analysis result into a database.

10. The method according to claim 9, the method further comprises:
creating an index of each word of the plurality of words and the relevant data of each word in the database by the server; and
searching for the at least one keyword and the relevant data corresponding to each keyword in the database based on the index.

11. The method according to claim 9, wherein the method further comprises:
uploading the at least one keyword to the server in response to a trigger operation on a preset hot key of the electronic device by a user; or
uploading the at least one keyword to the server in response to start a keyword link matching function of the electronic device.

12. The method according to claim 9, wherein the method further comprises:
detecting the number of occurrences of each word in the currently displayed page of the electronic device; and
determining that words with number of occurrences greater than or equal to a preset number of times are keywords.

13. The method according to claim 9, wherein the method further comprises:
identifying a domain of each word in the currently displayed page;
determining whether the identified domain of each word is the same as a preset domain; and
determining that the word is a keyword if the identified domain of the word is the same as the preset domain.

14. The method according to claim 9, wherein the method further comprises:
detecting whether each word in the currently displayed page has appeared in the historical browsing data stored in the storage device; and
determining that words that have not appeared in the historical browsing data are keywords.

15. A non-transitory storage medium having stored thereon instructions that, when executed by a processor of an electronic device, causes the processor to perform a link of keyword establishing method, the electronic device comprising a display screen, the method comprising:
detecting at least one keyword in a currently displayed page of the electronic device;
uploading the at least one keyword to a server;
receiving a link of relevant data of each keyword from the server; and
displaying the link of the relevant data corresponding to each keyword in the currently displayed page of the display screen.

16. The non-transitory storage medium according to claim 15, wherein the method further comprises:
obtaining a plurality of words from the currently displayed page of the electronic device;
acquiring relevant data of each word of the obtained words;
obtaining an analysis result by analyzing the plurality of words and the acquired relevant data;
storing the analysis result into a database.

17. The non-transitory storage medium according to claim 16, wherein the method further comprises:
creating an index of each word of the plurality of words and the relevant data of each word in the database by the server; and
searching for the at least one keyword and the relevant data corresponding to each keyword in the database based on the index.

18. The non-transitory storage medium according to claim 16, wherein the method further comprises:
uploading the at least one keyword to the server in response to a trigger operation on a preset hot key of the electronic device by a user; or
uploading the at least one keyword to the server in response to start a keyword link matching function of the electronic device.

19. The non-transitory storage medium according to claim 16, wherein the method further comprises:
detecting the number of occurrences of each word in the currently displayed page of the electronic device; and
determining that words with number of occurrences greater than or equal to a preset number of times are keywords.

20. The non-transitory storage medium according to claim 16, wherein the method further comprises:
identifying a domain of each word in the currently displayed page;
determining whether the identified domain of each word is the same as a preset domain; and
determining that the word is a keyword if the identified domain of the word is the same as the preset domain.
